(19) United States
(12) Patent Application Publication
(10) Pub. No.: US 2017/0251712 A1
(43) Pub. Date: Sep. 7, 2017

(54) Olive pitter

(71) Applicant: Donald M. Landis, Sebastopol, CA (US)

(72) Inventor: Donald M. Landis, Sebastopol, CA (US)

(21) Appl. No.: 15/330,958

(22) Filed: Jul. 10, 2015

(51) Int. Cl. A23N 4/08

(52) U.S. Cl. CPC A23N 4/085

(57) ABSTRACT

An olive pitter that uses a manually operated drive shaft assembly to pit an olive. The drive shaft assembly is connected to a needle that is positioned above an olive holder. A control arm that is connected to the drive shaft assembly is operated by the user to drive the needle downward and through the olive, pushing the pit out of the olive.

### CROSS-REFERENCES TO RELATED APPLICATIONS

This application claims priority to provisional application No. 62/028,227 filed Jul. 24, 2014, the entire disclosure of which is incorporated herein by this reference.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

1. Field of the Invention

The present invention relates generally to kitchen tools and accessories. More specifically, the present invention relates to a device used to remove pits from olives with minimal impact to the fruit and with minimal effort.

2. Description of the Related Art

Most devices used to remove pits from small fruits such as olives and cherries are hand-held clamping devices that hold the fruit on one side of a receptacle while forcing a plunger through the fruit to push the pit out. Although these tools tend to work well for pitting cherries and other softer fruit, the tools are not suitable for pitting olives because of the excessive force required to push a pit through the very firm meat of the olive.

Another drawback of the hand-held devices is that the receptacle to hold the fruit is generally sized for an average size piece of fruit and is not adjustable. Because olives of different varieties have a broad range of sizes of the fruit, the hand-held devices can only be used on a limited number of olive varieties.

The present invention addresses these issues by providing a sturdy and stable mechanism to pit an olive with minimal effort. The invention includes an olive holder with several size options so the mechanism can be used to pit any size olive. An olive is placed in the olive holder and an external handle connected to a gear mechanism is used to force a needle through the olive, pushing the pit out with minimal effort.

### BRIEF SUMMARY OF THE INVENTION

The present invention is an olive pitter with a structure suitable for setting on a counter top. The structure consists of a base and an upright frame that supports a mechanical housing. Inside the mechanical housing is a gear mechanism that connects a control arm to a vertically aligned needle. The needle is positioned over an olive holder. The olive holder has a hole that is large enough to allow the pit to pass through, but small enough to hold the exterior of the olive. The olive holder preferably has several holes of various sizes to accommodate different sized olives. The operator manually positions the olive holder such that the desired hole size is under the needle and places an olive in the hole. The operator then rotates the control arm downward, rotating the gear that is connected to the needle, and driving the needle downward through the olive. The needle forces the olive pit out of the olive without significantly damaging the meat of the olive. There is a receptacle under the olive holder that catches the olive pit for disposal.

### BRIEF DESCRIPTION OF THE SEVERAL VIEWS OF THE DRAWINGS

A more complete understanding of the present invention may be derived by referring to the detailed description and claims when considered in connection with the figures, wherein like reference numbers refer to similar items throughout the figures and:

FIG. 1 is a perspective view of the present invention, shown with the control arm in the upward position such that the needle is raised and with the smallest hole in the olive holder positioned under the needle.

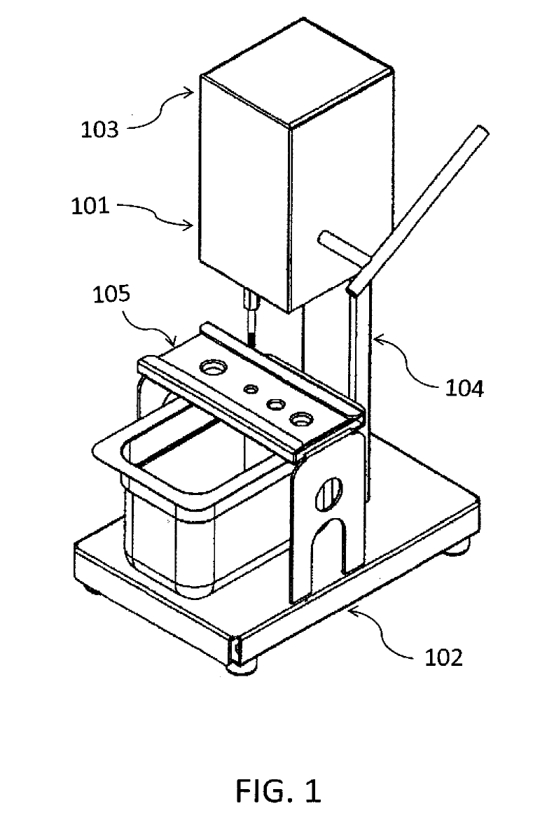

FIG. 2 is a perspective view of the back of the invention as fully assembled.

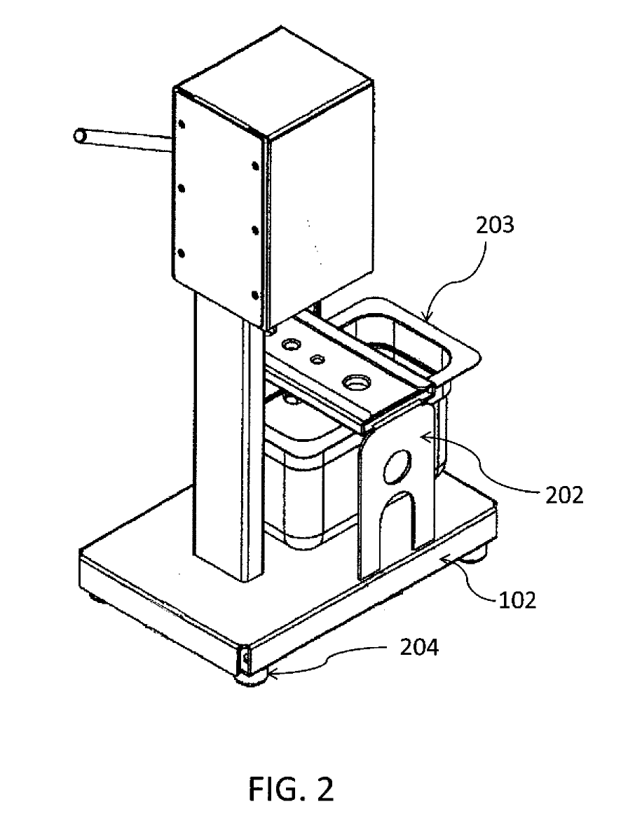

FIG. 3 is a back view of the inside of the mechanical housing showing the handle connected to the drive shaft, the position of the gear, the position of the needle guide, and the gear engaging the needle through the cut-out in the needle guide.

FIG. 4 is a perspective view of the handle, drive shaft with external gear and needle.

FIG. 5 is a close up perspective view of the base with the pit receptacle and olive holder and showing the direction of motion for adjustment of the olive holder to select different sized holes.

### DETAILED DESCRIPTION OF THE INVENTION

In the following detailed description of the invention, reference is made to the accompanying drawings which form a part of the disclosure and, which show by way of illustration, and not of limitation, specific embodiments by which the invention may be practiced. The drawings, the foregoing discussion, and the following description are exemplary and explanatory only, and are not intended to limit the scope of the invention or its application in any manner.

The present invention is an Olive Pitter 101 comprised of a Base 102, a Mechanical Housing 103 on a Support Frame 104, an Olive Holder 105 on Olive Holder Support 202, and a Pit Receptacle 203. The Mechanical Housing 103 contains a fixed Needle Guide 301, and a Gear 302 on a Drive Shaft 402 which is connected to a Control Arm 304. A Needle 401 with teeth that engage the Gear 302 is removably installed inside the Needle Guide 301. All of the structural and moving components of the invention are preferably made from food grade stainless steel, but could also be made from a sturdy plastic suitable for use in commercial kitchens. Other components, such as Feet 204 on the Base 102, or covering caps for screws or other connectors may be made from appropriate rubber or plastic material.

The Base 102 is a flat plate or assembly of sufficient weight and stiffness to support the Support Frame 104 and the Olive Holder Support 202. The Support Frame 104 and the Olive Holder Support 202 are firmly attached to the Base 102 such that the Needle 401 is positioned over the holes in the Olive Holder 105 when it is installed in the Olive Holder Support 202. The attachment means for the Support Frame 104 and the Olive Holder Support 202 may be via screws, welding, or any other suitable method. The Base 102 preferably has rubber or plastic Feet 204 attached to the bottom that are suitable for preventing damage to countertops.

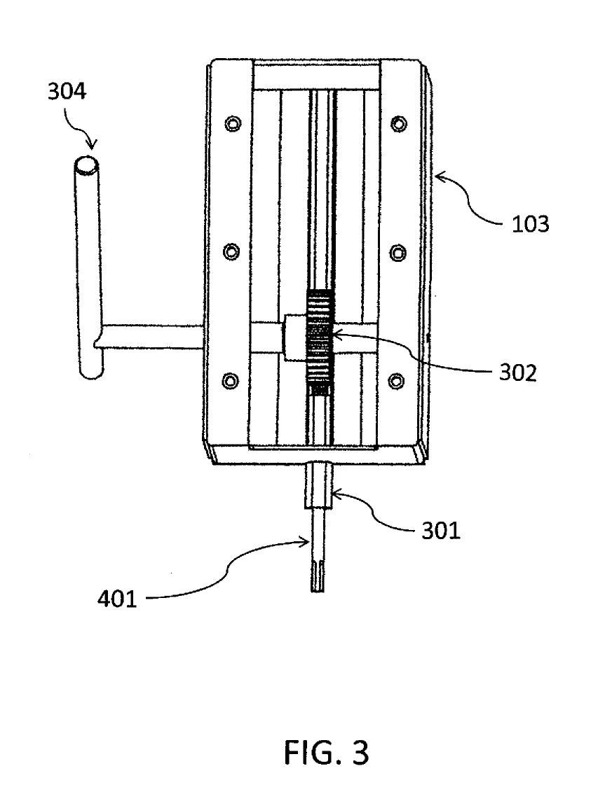

The Mechanical Housing 103 is a rectangular box firmly attached to the top of the Support Frame 104. A Needle Guide 301 consisting of a tube that is slightly larger than the external dimensions of the Needle 401 is permanently fixed in a vertical orientation inside the Mechanical Housing 103 as shown in FIG. 3. A rotatable Drive Shaft 402, which is fixed to a Gear 302, is positioned horizontally inside the Mechanical Housing 103 such that the teeth of the Gear 302 engage the teeth of the Needle 401. The Needle Guide 301 has an open section at the Gear 302 and Needle 401 interface to allow the teeth to connect as shown in FIG. 3. A Control Arm 304 is firmly connected to the Drive Shaft 402 and positioned such that when the Needle 401 is in the raised position, the Control Arm 304 is in the raised position.

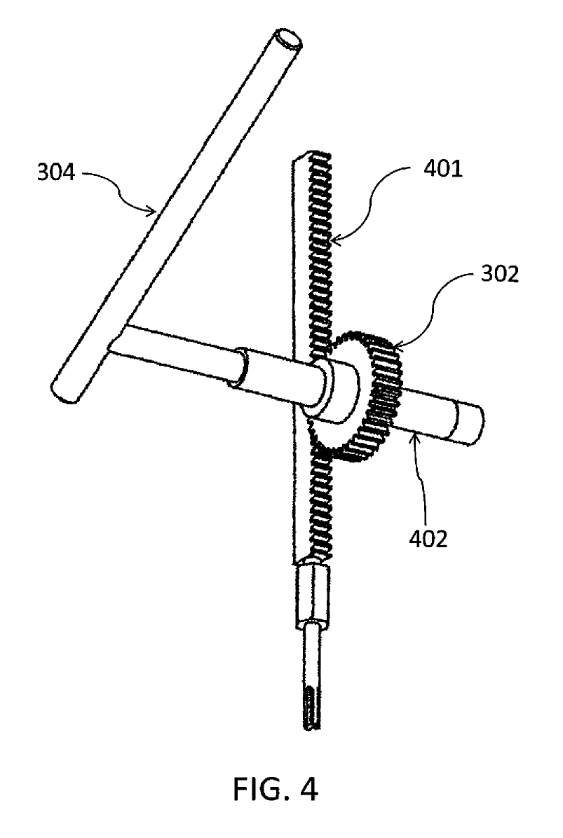

The Control Arm 304 is of suitable length to provide sufficient leverage to force a pit through any olive with minimal effort. In an alternate embodiment, there are means internal or external to the Mechanical Housing 103 to restrict the overall motion of the Control Arm 304 to prevent over-rotation. Such means may be a mechanical stop mechanism for the Control Arm 304, the Gear 302 or the Needle 401. The Needle 401 has a top portion with gear teeth suitable for engaging the Gear 302, and a bottom portion that has a tip of appropriate size to push a pit through an olive as shown in FIG. 4. The tip of the Needle 401 preferably has an “X” or similar configuration to aid in piercing the meat of the olive. The Needle 401 is preferably removable from the Needle Guide 301 to facilitate cleaning. In an alternate embodiment, the bottom end of the Needle 401 may be removable from the geared portion so that only the tip may be easily removed for cleaning.

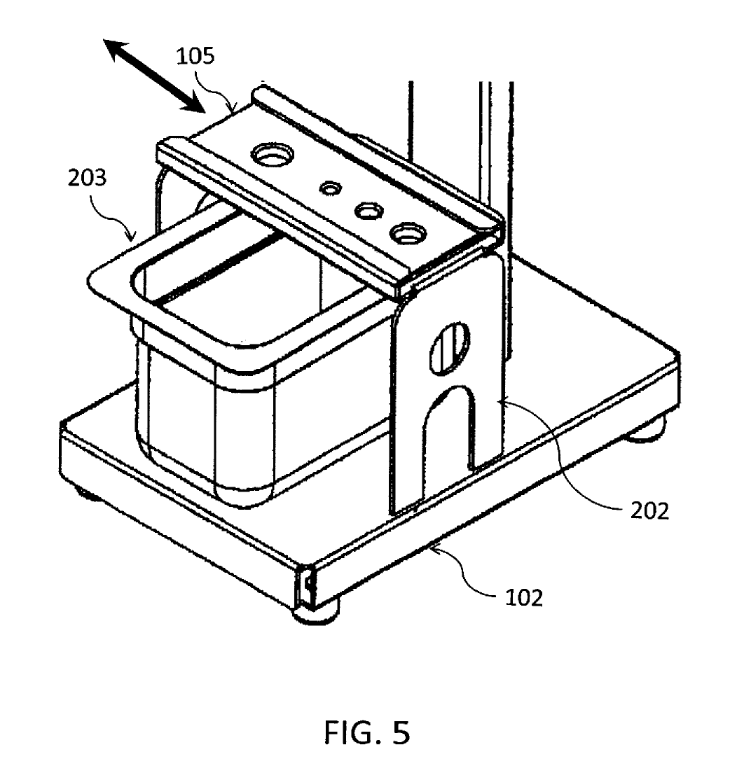

The Olive Holder Support 202 is securely attached to the Base 102 and is of suitable height to allow the Pit Receptacle 203 to easily slide under the Olive Holder 105. The Olive Holder Support 202 may be of any suitable configuration that will firmly support the Olive Holder 105 during the pitting operation. The top of the Olive Holder Support 202 has a configuration that allows the Olive Holder 105 to slide in and out of the Olive Holder Support 202 as indicated in FIG. 5. In a preferred embodiment, the Olive holder Support 202 and Olive Holder 105 include an indexing mechanism such that the Olive Holder 105 snaps into position for any of the holes selected by the user. Such an indexing mechanism may comprise a low force spring and a plunger on the Olive Holder Support 202 with matching dimples on the Olive Holder 105, but any other suitable indexing mechanism could be used.

The holes on the Olive Holder 105 are of sizes appropriate for a variety of olives. There are preferably four holes that will accommodate the smallest to the largest common varieties of olives. The holes preferably have a small bevel at the top to aid in supporting the olive as shown in FIG. 5.

To use the Olive fitter 101, the user places the Pit Receptacle 203 under the Olive Holder Support 202 and brings the Control Arm 304 to the highest position to raise the Needle 401. The user then selects the appropriate hole size depending on the olive variety that will be pitted and slides the Olive Holder 105 such that the selected hole is directly beneath the Needle 401. The user then rotates the Control Arm 304 downward, driving the tip of the Needle 401 through the olive and forcing the pit out and into the Pit Receptacle 203.

Many modifications and variations of this invention may be made without departing from its spirit and scope, as will be appreciated by those skilled in the art. The specific embodiments described herein are offered by way of example only. The embodiments were chosen and described in order to best explain the principles of the invention and its practiced applications.

What is claimed is:

1. An olive pitter for removing a pit from an olive, the olive pitter comprising:
(a) a base;
(b) a mechanical housing mounted to the base, the mechanical housing containing a fixed vertical needle guide and a rotatable horizontal drive shaft with an external gear;
(c) a needle with a top end and a bottom end, the top end having teeth configured to engage the external gear on the rotatable horizontal drive shaft, and the bottom end being configured to enter an olive and push a pit out of the olive, the needle being positioned within the vertical needle guide such that its teeth engage the external gear and when the external gear rotates, the needle moves up and down;
(d) a control arm connected to the rotatable horizontal drive shaft that extends out of the mechanical housing, such that when a user pulls down on the control arm, the drive shaft rotates; and
(e) an olive holder comprising at least one hole positioned above the base, the hole being configured to hold an olive, the olive holder being positioned under the bottom end of the needle, such that when the needle moves downward it pushes the pit out of the olive, and the pit falls through the hole on the olive holder.

2. The olive pitter in accordance with claim 1, wherein the olive holder has four holes of different sizes, and wherein the olive holder can be moved to align any of the holes under the bottom end of the needle.

3. The olive pitter in accordance with claim 1 with a removable pit receptacle positioned under the olive holder.
